(19) United States
(12) Patent Application Publication
(10) Pub. No.: US 2026/0175408 A1
(43) Pub. Date: Jun. 25, 2026

(54) ACTUATOR ASSEMBLY WITH LOAD-DISTRIBUTION FEATURES AND RELATED TECHNOLOGY

(71) Applicant: Agility Robotics, Inc., Pittsburgh, PA (US)

(72) Inventor: Kevin Sweeney, Albany, OR (US)

(21) Appl. No.: 19/060,518

(22) Filed: Feb. 21, 2025

Related U.S. Application Data
(60) Provisional application No. 63/737,449, filed on Dec. 20, 2024.

(51) Int. Cl. B25J 9/10; B25J 9/12; F16H 37/12

(52) U.S. Cl. CPC B25J 9/102; B25J 9/126; F16H 37/122

(57) ABSTRACT

An actuator assembly in accordance with at least some embodiments of the present technology includes a first link, a second link, and a joint therebetween. The actuator assembly also includes a motor and gearing at the joint. The motor includes a stator and a rotor that rotates relative to the stator about an axis. The gearing includes a first transfer member defining first openings circumferentially distributed about the axis. Similarly, the gearing includes a second transfer member defining second openings circumferentially distributed about the axis. The actuator assembly further includes rods carried by the first link, circumferentially distributed about the axis, and individually extending through different respective sets of one of the first openings and one of the second openings. The first link structurally braces the rods via opposite respective end portions of the rods.

### CROSS-REFERENCE TO RELATED APPLICATION

This claims the benefit of U.S. Provisional Application No. 63/737,449, filed Dec. 20, 2024. The foregoing application is incorporated herein by reference in its entirety. To the extent the foregoing application or any other material incorporated by reference conflicts with the present disclosure, the present disclosure controls.

### TECHNICAL FIELD

The present technology relates to actuator assemblies, such as robot actuator assemblies with cycloidal gearing.

### BACKGROUND

Much of the work that humans currently perform is amenable to automation using robotics. For example, large numbers of human workers currently focus on executing actions that require little or no reasoning, such as predefined relocations of items and containers at order-fulfillment centers. Such actions may occur millions of times a day at a single order-fulfillment center and billions of times a day across a network of order-fulfillment centers. Human effort would be better applied to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIGS. 1-3, respectively, are different perspective views of an actuator assembly in accordance with at least some embodiments of the present technology.

FIG. 4 is an exploded perspective view of the actuator assembly of FIGS. 1-3.

FIG. 5 is a side profile view of a first transfer member of gearing of the actuator assembly of FIGS. 1-3.

FIG. 6 is a side profile view of a second transfer member of the gearing of the actuator assembly of FIGS. 1-3.

FIG. 7 is a side profile view of the actuator assembly of FIGS. 1-3.

FIG. 8 is a cross-sectional view of the actuator assembly of FIGS. 1-3 taken along the line A-A in FIG. 7.

FIGS. 9-11, respectively, are exploded perspective views of the actuator assembly of FIGS. 1-3 at increasingly more granular levels of detail.

FIG. 12 is a block diagram corresponding to a mobile robot including an actuator assembly in accordance with at least some embodiments of the present technology.

FIG. 13 is a block diagram corresponding to a method involving an actuator assembly in accordance with at least some embodiments of the present technology.

### DETAILED DESCRIPTION

Robots perform mechanical work via actuators. A typical actuator in an electromechanical robot includes a motor and gearing operably associated with one another. The motor includes a rotor and a stator. It uses electricity from a power source to rotate the rotor relative to the stator about an axis at high speed and low torque. A transfer structure then transfers this torque from the rotor to the gearing. The gearing decreases the speed and increases the torque, thereby causing an output from the actuator to be suitable for a controlled mechanical action, such as moving a link relative to another link via a joint in a robot. There are several types of gearing suitable for use in robot actuators. In cycloidal gearing, as one such type, the transfer structure typically includes an input shaft carrying eccentric bearings. When an associated motor rotates the input shaft about an axis, the eccentric bearings transfer force to transfer members (e.g., cycloidal disks) of the cycloidal gearing. Peripheral portions of the transfer members have circumferentially alternating lobes and troughs that interact with a ring gear of the cycloidal gearing to cause relative circumferential movement about the axis between the ring gear and the transfer members. Output from the cycloidal gearing is captured via the ring gear and/or via the transfer members depending on how the cycloidal gearing is mounted to neighboring structures.

Among its potential advantages, cycloidal gearing tends to exhibit relatively high efficiency, transparency, and shock resistance. Cycloidal gearing, however, also has potential disadvantages. For example, conventional cycloidal gearing can exhibit relatively low mass efficiency and compactness. Actuator assemblies and related devices, systems, and methods in accordance with embodiments of the present technology at least partially address these and/or other problems or limitations associated with conventional technologies. An actuator assembly in accordance with at least some embodiments of the present technology includes cycloidal gearing and a ground that interacts with transfer members of the cycloidal gearing to provide excellent load distribution and stiffness without unduly compromising mass efficiency or compactness. In a particular example, the ground includes a yoke that supports rods extending through transfer members of the cycloidal gearing from both ends of the rods. In contrast, a ground of conventional cycloidal gearing may support such rods in a cantilevered manner from only one end of the rods. The conventional cantilevered, one-ended support configuration is more intuitive than the non-cantilevered, two-ended support configuration in accordance with at least some embodiments of the present technology, but is disadvantageous for load distribution and/or stiffness. This, in turn, at least partially causes relatively poor mass efficiency, relatively poor compactness, and/or other problems in conventional cycloidal gearing.

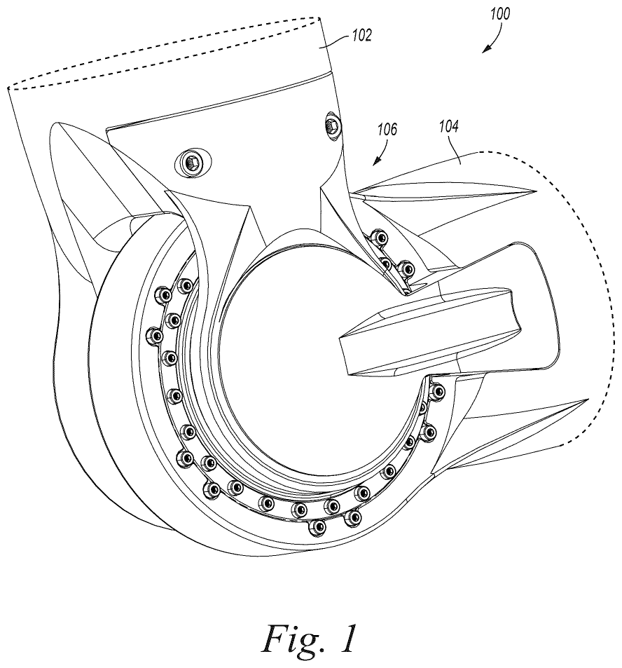

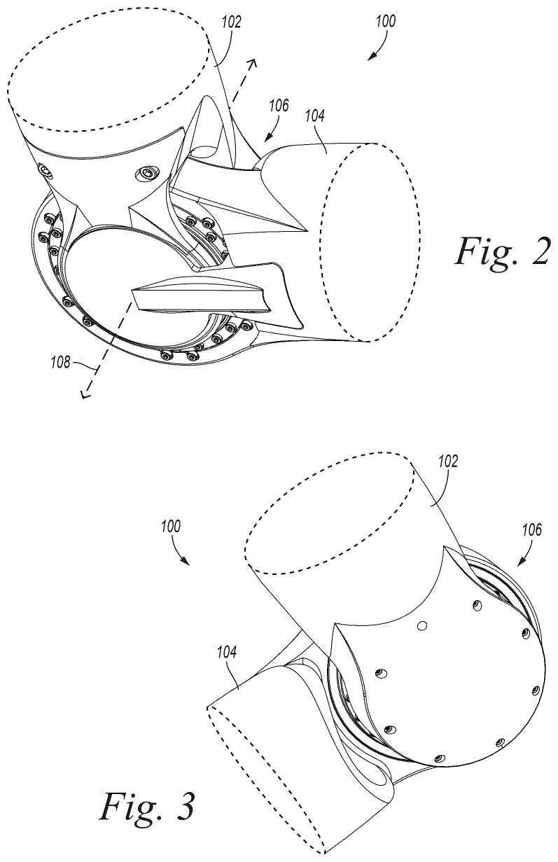

The foregoing and other features of devices, systems, and methods in accordance with various embodiments of the present technology are further described below with reference to FIGS. 1-13. Although methods, devices, and systems may be described herein primarily or entirely in the context of actuator assemblies of mobile robots, other contexts are within the scope of the present technology. For example, suitable features of described methods, devices, and systems can be implemented in the context of stationary robots or in non-robot contexts that call for actuator assemblies with cycloidal gearing, such as certain vehicles, pumps, winches, etc. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Actuator Assemblies

FIGS. 1-3, respectively, are different perspective views of an actuator assembly 100 in accordance with at least some embodiments of the present technology. With reference to FIGS. 1-3 together, the actuator assembly 100 can include a first link 102, a second link 104, and a joint 106 therebetween. In the illustrated embodiment, the actuator assembly 100 is a serial linkage in which first link 102 is a ground and proximal to the second link 104. The actuator assembly 100 is configured to cause the second link 104 to rotate relative to the first link 102 about an axis 108. In another embodiment, a counterpart of the actuator assembly 100 can be configured to cause an opposite relative motion. In addition or alternatively, the proximal-to-distal relationship of the first and second links 102, 104 can be reversed. Also in addition or alternatively, a counterpart of the actuator assembly 100 can be another type of linkage. For example, a counterpart of the actuator assembly 100 can be a four-bar linkage in which the second link 104 includes a crank and the actuator assembly 100 includes a connecting rod rotatably connected to the crank. With reference again to the illustrated embodiment, the actuator assembly 100 can include features that promote load distribution, compactness, efficiency, and/or other advantages over conventional counterparts.

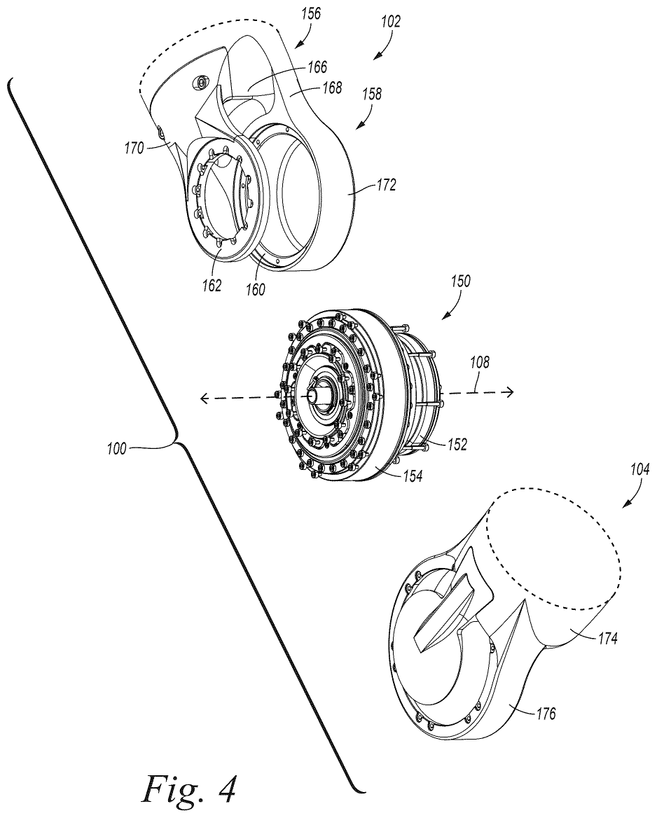

FIG. 4 is an exploded perspective view of the actuator assembly 100. As shown in FIG. 4, the actuator assembly 100 can include an intermediate assembly 150 between the first and second links 102, 104. The intermediate assembly 150 can include a first portion 152 and a second portion 154 adjacent to one another along the axis 108. An average diameter of the intermediate assembly 150 perpendicular to the axis 108 can be smaller at the first portion 152 than it is at the second portion 154. The first link 102 can include a first body 156 and a yoke 158 distally carried by the first body 156. As parts of the yoke 158, the first link 102 can include a first securement ring 160 extending distally from the first body 156. Similarly, the first link 102 can include a second securement ring 162 extending distally from the first body 156. The first and second securement rings 160, 162 can be spaced apart from one another along the axis 108. In at least some cases, the first link 102 is configured to provide double-shear load distribution via the first and second securement rings 160, 162. In these and other cases, the first link 102 can include a structural bridge 166 at which loads on the first and second securement rings 160, 162 converge. Relatedly, the first link 102 can include first and second structural connectors 168, 170 extending between the structural bridge 166 and the first and second securement rings 160, 162, respectively. The first link 102 can further include a housing 172 configured to at least partially contain the first portion 152 of the intermediate assembly 150. The first securement ring 160 can be adjacent to the housing 172 along the axis 108.

As discussed in greater detail below, a motor (not labeled in FIG. 4) and gearing (also not labeled in FIG. 4) of the actuator assembly 100 can be at the first and second portions 152, 154 of the intermediate assembly 150, respectively. The actuator assembly 100 can be configured to transfer an output torque from the gearing and from the second portion 154 of the intermediate assembly 150 to the second link 104 directly while also supporting the gearing and the second portion 154 of the intermediate assembly 150 from opposite respective sides of these structures along the axis 108 via the first link 102. This is different from conventional counterparts in which gearing is supported from only one side. With reference again to FIG. 4, the second link 104 can include a second body 174 and a collar 176 extending proximally from the second body 174. The collar 176 can extend around the second portion 154 of the intermediate assembly 150 in a plane perpendicular to the axis 108 and between the first and second securement rings 160, 162 along the axis 108. The actuator assembly 100 can be configured to transfer output torque from the gearing to the second link 104 via the collar 176.

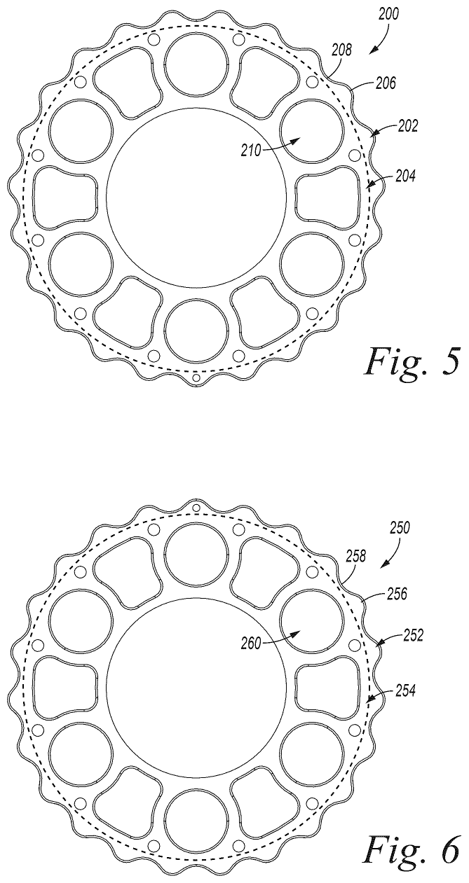

FIG. 5 is a side profile view of a first transfer member 200 of the gearing of the actuator assembly 100. The first transfer member 200 is shown in isolation for purposes of clarity ahead of further discussion below regarding how the first transfer member 200 interacts with other structures of the actuator assembly 100. As shown in FIG. 5, the first transfer member 200 can include a first annular peripheral region 202 and a first annular inner region 204 shown in FIG. 5 outside and inside, respectively, a dashed circle. The first transfer member 200 can further include first lobes 206 (one labeled) and first troughs 208 (one labeled) at the first annular peripheral region 202. The first transfer member 200 can also define first openings 210 (one labeled) at the first annular inner region 204. In the actuator assembly 100, the first annular inner region 204 can be between the first annular peripheral region 202 and the axis 108. The first lobes 206 and the first troughs 208 can be circumferentially alternating about the axis 108. Finally, the first openings 210 can be circumferentially distributed about the axis 108.

FIG. 6 is a side profile view of a second transfer member 250 of the gearing of the actuator assembly 100. As with the first transfer member 200, the second transfer member 250 is shown in isolation for purposes of clarity ahead of further discussion below regarding how the second transfer member 250 interacts with other structures of the actuator assembly 100. As shown in FIG. 6, the second transfer member 250 can include a second annular peripheral region 252 and a second annular inner region 254 shown in FIG. 6 outside and inside, respectively, a dashed circle. The second transfer member 250 can further include second lobes 256 (one labeled) and second troughs 258 (one labeled) at the second annular peripheral region 252. The second transfer member 250 can also define second openings 260 (one labeled) at the second annular inner region 254. In the actuator assembly 100, the second annular inner region 254 can be between the second annular peripheral region 252 and the axis 108. The second lobes 256 and the second troughs 258 can be circumferentially alternating about the axis 108. Finally, the second openings 260 can be circumferentially distributed about the axis 108. In at least some cases, the first and second transfer members are two instances of the same part.

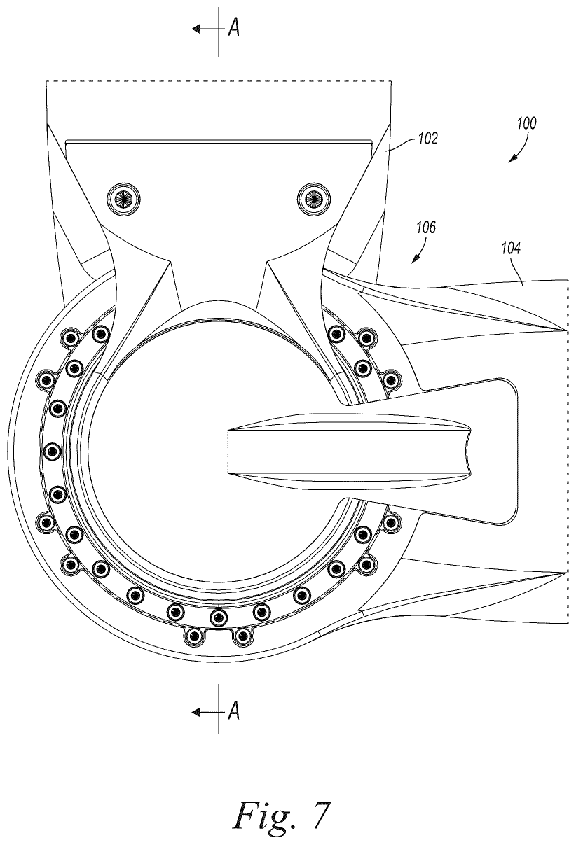

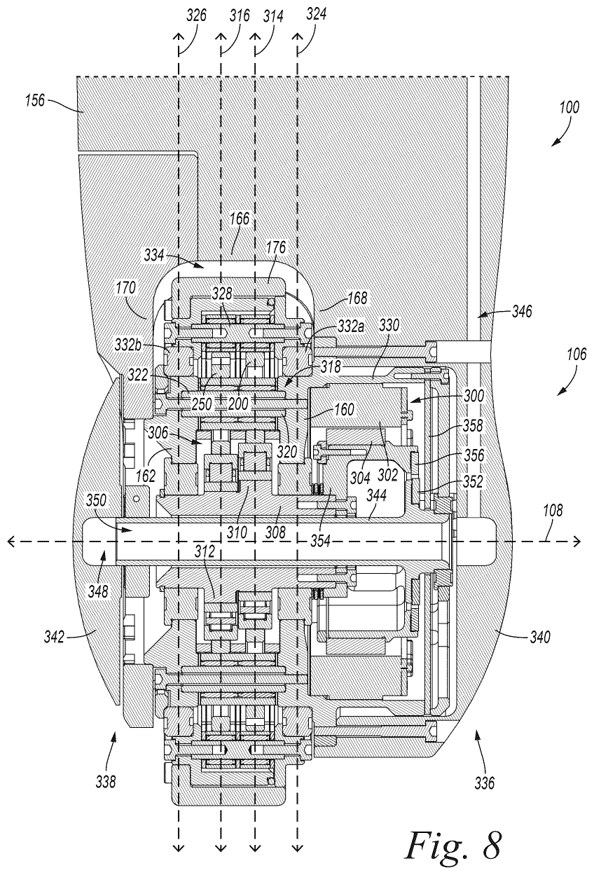

FIG. 7 is a side profile view of the actuator assembly 100. FIG. 8 is a cross-sectional view of the actuator assembly 100 taken along the line A-A in FIG. 7. With reference now to FIGS. 1-8 together, the actuator assembly 100 can include a motor 300 at the joint 106. The motor 300 can include a rotor 302 and a stator 304 and can be configured to rotate the rotor 302 relative to the stator 304 about the axis 108. The actuator assembly 100 can also include gearing 306 at the joint 106 and operably associated with the motor 300. The gearing 306 can be cycloidal type and can include the first and second transfer members 200, 250. The actuator assembly 100 can further include an input shaft 308 configured to rotate about the axis 108. Within the gearing 306, the first and second transfer members 200, 250 can be configured to transfer force received from the motor 300 via the input shaft 308. The actuator assembly 100 can include a first eccentric bearing 310 carried by the input shaft 308 and configured to transfer force to the first transfer member 200 in response to rotation of the input shaft 308. Similarly, the actuator assembly 100 can include a second eccentric bearing 312 carried by the input shaft 308 and configured to transfer force to the second transfer member 250 in response to rotation of the input shaft 308. As shown in FIG. 8, the first transfer member 200 and the first eccentric bearing 310 can be at a first plane 314 perpendicular to the axis 108. Similarly, the second transfer member 250 and the second eccentric bearing 312 can be at a second plane 316 perpendicular to the axis 108.

The actuator assembly 100 can further include rods 318 (one labeled) circumferentially distributed about the axis 108 and individually extending through different respective sets of one of the first openings 210 and one of the second openings 260. The rods 318 can be carried by the first link 102 and can individually include a first end portion 320 and a second end portion 322 opposite to one another in a dimension parallel to the axis 108. As shown in FIG. 8, the first end portions 320 of the rods 318 can be at a third plane 324 perpendicular to the axis 108. Similarly, the second end portions 322 of the rods 318 can be at a fourth plane 326 perpendicular to the axis 108. The first and second planes 314, 316 can be between the third and fourth planes 324, 326. In at least some cases, the actuator assembly 100 structurally braces the rods 318 via the first and second end portions 320, 322 of the rods 318. Furthermore, the actuator assembly 100 can carry the rods 318 between the first and second securement rings 160, 162. The first structural connector 168 can extend between the rods 318 and the structural bridge 166 via the first end portions 320 of the rods 318. Similarly, the second structural connector 170 can extend between the rods 318 and the structural bridge 166 via the second end portions 322 of the rods 318. The structural bridge 166, in turn, can extend between the third and fourth planes 324, 326.

The actuator assembly 100 can also include pins 328 (one labeled) circumferentially distributed about the axis 108. The collar 176 can carry the pins 328, which, like the structural bridge 166, can extend between the third and fourth planes 324, 326. Relatedly, the gearing 306 can be configured to transfer torque to the collar 176 via the pins 328. The first link 102 can include a stator mount 330 carrying the stator 304. In at least some cases, the first securement ring 160 is integrally connected to the stator mount 330. The actuator assembly 100 can include annular roller bearings 332 (individually identified as annular roller bearings 332a, 332b) that facilitate rotation of the collar 176 relative to the first link 102. In particular, the annular roller bearing 332a can be between the stator mount 330 and the collar 176 at the third plane 324. Likewise, the annular roller bearing 332a can be between the first securement ring 160 and the collar 176 at the third plane 324. The annular roller bearing 332b can be between the second securement ring 162 and the collar 176 at the fourth plane 326.

In at least some cases, the actuator assembly 100 defines a gap 334 between the collar 176 and the structural bridge 166. As best shown with reference to FIGS. 5 and 8 together, a radial distance between the first annular peripheral region 202 and the axis 108 at the first plane 314 can be less than a radial distance between the structural bridge 166 and the axis 108 at the first plane 314. Similarly, as best shown with reference to FIGS. 6 and 8 together, a radial distance between the second annular peripheral region 252 and the axis 108 at the second plane 316 can be less than a radial distance between the structural bridge 166 and the axis 108 at the second plane 316. As best shown with reference to FIGS. 4 and 8 together, the structural bridge 166 can be less than fully circumferential about the axis 108. For example, the structural bridge 166 can circumferentially extend less than 200 degrees about the axis 108. Now with reference again to FIGS. 1-8 together, the first and second bodies 156, 174 can neighbor the joint 106 proximally and distally, respectively. The axis 108, in contrast, can extend laterally through the joint 106. The joint 106 can include a first end portion 336 and a second end portion 338 spaced apart from one another along the axis 108. The first link 102 can include a first cap 340 at the first end portion 336 of the joint 106. Similarly, the second link 104 can include a second cap 342 at the second end portion 338 of the joint 106.

Features of the actuator assembly 100 can promote efficient and reliable routing of wiring within and through the joint 106. Relatedly, the actuator assembly 100 can include a conduit 344 extending along the axis 108. The rotor 302, the stator 304, and the input shaft 308 can extend circumferentially around the conduit 344. At the first link 102, the first cap 340 and the first body 156 can define a first channel 346 extending proximally away from the joint 106. Similarly, at the second link 104, the second cap 342 and the second body 174 can define a second channel 348 extending distally away from the joint 106. The conduit 344 can define a third channel 350 extending through the joint 106 along the axis 108 between the first and second channels 346, 348. The actuator assembly 100 can include wiring (not shown) extending between the first and second links 102, 104 via the first, second, and third channels 346, 348, 350. The actuator assembly 100 can further include a first encoder target 352 carried by the conduit 344. The actuator assembly 100 can still further include a rotor mount 354 and a second encoder target 356 carried by the rotor mount 354. Finally, the actuator assembly 100 can include an encoder board 358 carried by the stator mount 330 and operably associated with the first and second encoder targets 352, 356. The wiring extending through the first channel 346 can include control wiring for the encoder board 358 and supply wiring for the motor 300. The wiring extending through the first, second, and third channels 346, 348, 350 can include control and/or supply wiring for electrical components distal to the actuator assembly 100.

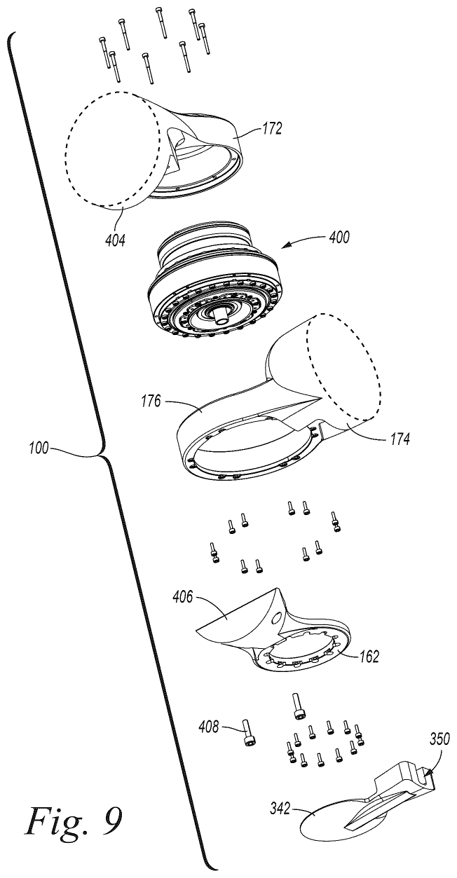

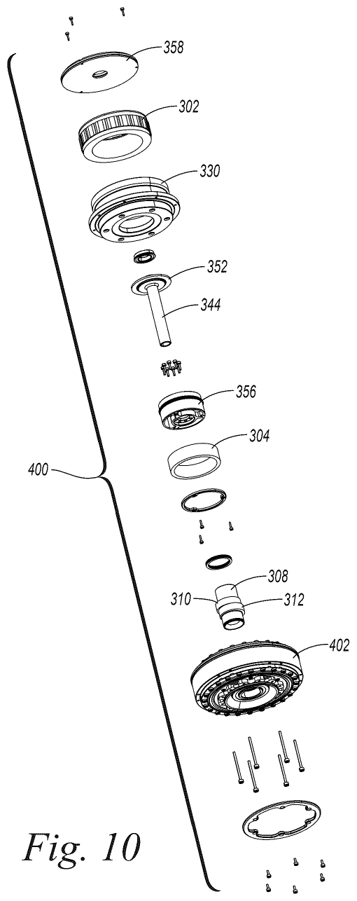

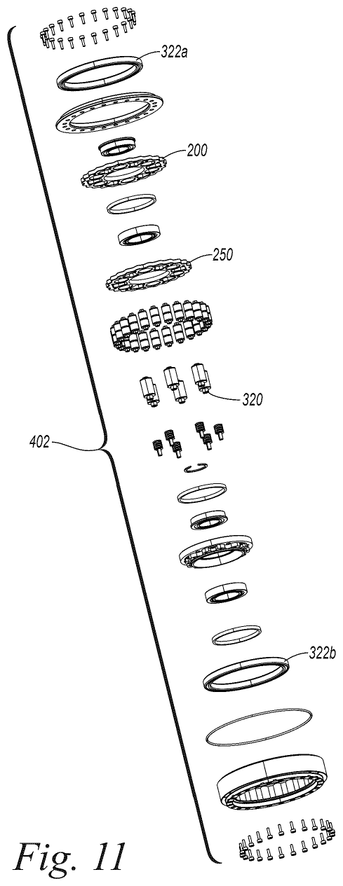

FIGS. 9-11, respectively, are exploded perspective views of the actuator assembly 100 at increasingly more granular levels of detail. In particular, FIG. 9 shows a first-level subassembly 400 of the actuator assembly 100 among other parts of the actuator assembly 100. FIG. 10 shows a second-level subassembly 402 of the first-level subassembly 400 among other parts of the first-level subassembly 400. Finally, FIG. 11 shows parts of the second-level subassembly 402. Among other things, FIGS. 9-11 illustrate aspects of how parts of the actuator assembly 100 fit together. With reference to FIGS. 1-11 together, the first link 102 can be configured to allow the yoke 158 to be split and then assembled around the gearing 306. Relatedly, the first body 156 can include a first portion 404, a second portion 406, and fasteners 408 (one labeled) through which the first and second portions 404, 406 of the first body 156 are detachably connected to one another. The first body 156 can carry the first and second securement rings 160, 162 via the first and second portions 404, 406 of the first body 156, respectively. Furthermore, an interface between the first and second portions 404, 406 of the first body 156 can extend through the structural bridge 166. Correspondingly, the first structural connector 168 and a first portion of the structural bridge 166 can be at the first portion 404 of the first body 156 while the second structural connector 170 and a second portion of the structural bridge 166 are at the second portion 406 of the first body 156.

### Examples of Robot Systems

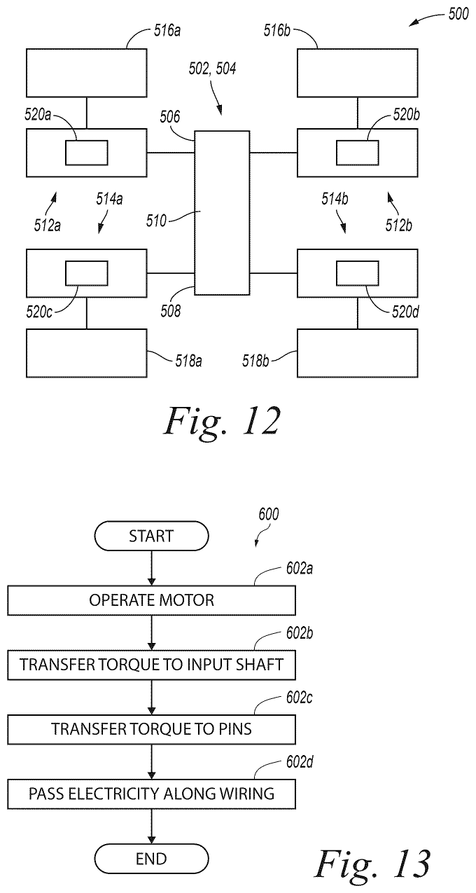

FIG. 12 is a block diagram corresponding to a mobile robot 500 including an actuator assembly in accordance with at least some embodiments of the present technology. In at least some cases, the mobile robot 500 includes structures resembling human anatomy with respect to the features, positions, and/or other characteristics of such structures. In these and other cases, the mobile robot 500 can define a midsagittal plane about which the mobile robot 500 is bilaterally symmetrical. Furthermore, the mobile robot 500 can be configured for bipedal locomotion similar to that of a human. Counterparts of the mobile robot 500 can have other suitable forms and features. For example, a counterpart of the mobile robot 500 can have a non-humanoid form, such as a canine form, an insectoid form, an arachnoid form, or a form with no animal analog. Still further, a counterpart of the mobile robot 500 can be asymmetrical or have symmetry other than bilateral. Also, a counterpart of the mobile robot 500 can be configured for non-bipedal locomotion. For example, a counterpart of the mobile robot 500 can be configured for another type of legged locomotion (e.g., quadrupedal locomotion, octopedal locomotion, etc.) and/or non-legged locomotion (e.g., wheeled locomotion, continuous-track locomotion, etc.).

The mobile robot 500 can include a centrally disposed body 502 through which other structures of the mobile robot 500 are interconnected. As all or a portion of the body 502, the mobile robot 500 can include a torso 504 having a superior portion 506, an inferior portion 508, and an intermediate portion 510 therebetween. The mobile robot 500 can further include articulated appendages carried by the torso 504. Among these articulated appendages, the mobile robot 500 can include arms 512a, 512b and legs 514a, 514b. In at least some cases, the mobile robot 500 is configured to manipulate objects via the arms 512a, 512b, such as bimanually. In these and other cases, the mobile robot 500 can be configured to ambulate via the legs 514a, 514b, such as bipedally. The arms 512a, 512b and the legs 514a, 514b can define kinematic chains. The kinematic chains corresponding to the arms 512a, 512b, for example, can provide at least five degrees of freedom, such as exactly five or exactly six degrees of freedom. In these and other cases, the kinematic chains corresponding to the legs 514a, 514b can provide at least four degrees of freedom, such as exactly four, exactly five, or exactly six degrees of freedom. As parts of the arms 512a, 512b, the mobile robot 500 can include end effectors 516a, 516b at distalmost portions of the corresponding kinematic chains. Similarly, as parts of the legs 514a, 514b, the mobile robot 500 can include feet 518a, 518b at distalmost portions of the corresponding kinematic chains.

At proximal ends and/or at other suitable points along the kinematic chains corresponding to the arms 512a, 512b and legs 514a, 514b, the mobile robot 500 can include respective joints (not shown). The mobile robot 500 can further include actuators 520 (individually identified as actuators 520a-520d) configured to cause motion at corresponding joints. The actuators 520a-520d can be adjacent to a corresponding joint or be connected to a corresponding joint in another suitable manner (e.g., via a connecting rod, a cable, etc.). In the illustrated embodiment, the actuator 520a is a component of the arm 512a, the actuator 520b is a component of the arm 512b, the actuator 520c is a component of the leg 514a, and the actuator 520d is a component of the leg 514b. In other embodiments, one or more of the actuators 520a-520d can be a component of the body 502.

In the illustrated and in other embodiments, at least one of the actuators 520a-520d and associated components of the mobile robot 500 can correspond to the actuator assembly 100 or another actuator assembly in accordance with at least some embodiments of the present technology. For example, the mobile robot 500 can include an actuator assembly with features in accordance with at least some embodiments of the present technology as the actuator 520a and operably associated with a shoulder joint, an elbow joint, or a wrist joint of the arm 512a. As another example, the mobile robot 500 can include an actuator assembly with features in accordance with at least some embodiments of the present technology as the actuator 520b and operably associated with a shoulder joint, an elbow joint, or a wrist joint of the arm 512b. As another example, the mobile robot 500 can include an actuator assembly with features in accordance with at least some embodiments of the present technology as the actuator 520c and operably associated with a hip joint, a knee joint, or an ankle joint of the leg 514a. As another example, the mobile robot 500 can include an actuator assembly with features in accordance with at least some embodiments of the present technology as the actuator 520d and operably associated with a hip joint, a knee joint, or an ankle joint of the leg 514b. Actuator assemblies in accordance with at least some embodiments of the present technology can be useful in many other locations in addition or alternatively. Furthermore, the mobile robot 500 is merely one example of a system in which features of at least some embodiments of the present technology can be implemented.

### Examples of Methods

FIG. 13 is a block diagram corresponding to a method 600 in accordance with at least some embodiments of the present technology. Although the method 600 will be described primarily in the context of the actuator assembly 100, it should be understood that suitable features of the method 600 can likewise be practiced in the contexts of another actuator assembly in accordance with at least some embodiment of the present technology. With reference to FIGS. 1-13 together, the method 600 can include operating the motor 300 (block 602a) to cause relative rotation between the first and second links 102, 104. This can also include rotating the rotor 302 relative to the stator 304 about the axis 108. The method 600 can further include changing an output of the motor 300 (e.g., by decreasing the speed and increasing the torque) via the gearing 306. In connection with changing the output of the motor 300, the method 600 can include transferring torque from the rotor 302 to the input shaft 308 (block 602b). Relatedly, the method 600 can include transferring force from the input shaft 308 to the first and second transfer members 200, 250 via the first and second eccentric bearings 310, 312, respectively. The method 600 can still further include transferring torque from the first and second transfer members 200, 250 to the pins 328 (block 602c) while changing the output of the motor 300. This can include transferring torque from the first transfer member 200 to at least some of the pins 328 via the first annular peripheral region 202 of the first transfer member 200. Similarly, transferring torque to the pins 328 can include transferring torque from the second transfer member 250 to at least some of the pins 328 via the second annular peripheral region 252 of the second transfer member 250.

Changing the output of the motor 300 can occur while the first link 102 structurally braces the rods 318 via the first and second end portions 320, 322 of the rods 318. Relatedly, changing the output of the motor 300 can occur while the first and second structural connectors 168, 170 structurally brace the rods 318 via the first and second end portions 320, 322 of the rods 318. Also relatedly, changing the output of the motor 300 can occur while the structural bridge 166 structurally connects the first and second structural connectors 168, 170 to one another. Finally, the method 600 can include passing electricity along the wiring extending between the first and second links 102, 104 (block 602d). This electricity can be for controlling or otherwise operating one of more electrical components distal to the actuator assembly 100. In at least some cases, passing the electricity along the wiring occurs while the wiring extends along the first, second, and third channels 346, 348, 350.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, or generating information in accordance with various embodiments of the present technology encompass, when feasible, the others of receiving, determining, and generating the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. The term “centroid” as used herein refers to a center-like data element for a given shape in three-dimensional space. There are several known approaches to calculating centroids including approaches of greater and lesser precision. No particular approach is contemplated herein. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

I/We claim:

1. An actuator assembly comprising:
a first link;
a second link;
a joint between the first and second links;
a motor at the joint and including a rotor and a stator, wherein the motor is configured to rotate the rotor relative to the stator about an axis;
gearing at the joint and operably associated with the motor, wherein the gearing includes:
a first transfer member at a first plane perpendicular to the axis, wherein the first transfer member includes a first annular peripheral region and a first annular inner region between the first annular peripheral region and the axis, wherein the first transfer member further includes first lobes and first troughs circumferentially alternating about the axis at the first annular peripheral region, and wherein the first transfer member defines first openings circumferentially distributed about the axis at the first annular inner region, and
a second transfer member at a second plane perpendicular to the axis, wherein the second transfer member includes a second annular peripheral region and a second annular inner region between the second annular peripheral region and the axis, wherein the second transfer member further includes second lobes and second troughs circumferentially alternating about the axis at the second annular peripheral region, and wherein the second transfer member defines second openings circumferentially distributed about the axis at the second annular inner region; and
rods carried by the first link, circumferentially distributed about the axis, and individually extending through different respective sets of one of the first openings and one of the second openings, wherein the rods individually include a first end portion and an opposite second end portion, wherein the first end portions of the rods are at a third plane perpendicular to the axis, wherein the second end portions of the rods are at a fourth plane perpendicular to the axis, wherein the first and second planes are between the third and fourth planes, and wherein the first link structurally braces the rods via the first and second end portions of the rods.

2. The actuator assembly of claim 1, further comprising:
an input shaft configured to rotate about the axis;
a first eccentric bearing carried by the input shaft at the first plane; and
a second eccentric bearing carried by the input shaft at the second plane,
wherein the first and second eccentric bearings are configured to transfer force to the first and second transfer members, respectively, in response to rotation of the input shaft.

3. The actuator assembly of claim 1, wherein the first link includes:
a structural bridge extending between the third and fourth planes, wherein a radial distance between the first annular peripheral region of the first transfer member and the axis is less than a radial distance between the structural bridge and the axis, and wherein a radial distance between the second annular peripheral region of the second transfer member and the axis is less than a radial distance between the structural bridge and the axis;
a first structural connector extending between the rods and the structural bridge via the first end portions of the rods; and
a second structural connector extending between the rods and the structural bridge via the second end portions of the rods.

4. The actuator assembly of claim 3, wherein the structural bridge circumferentially extends less than 200 degrees about the axis.

5. The actuator assembly of claim 1, wherein:
the first link includes:
a body neighboring the joint,
a first securement ring extending from the body, and
a second securement ring extending from the body and spaced apart from the first securement ring along the axis; and
the first link carries the rods between the first and second securement rings.

6. The actuator assembly of claim 5, wherein:
the body proximally neighbors the joint; and
the first and second securement rings extend distally from the body.

7. The actuator assembly of claim 5, wherein:
the body includes:
a first portion through which the body carries the first securement ring, and
a second portion through which the body carries the second securement ring; and
the first link includes fasteners through which the first and second portions of the body are detachably connected to one another.

8. The actuator assembly of claim 7, wherein:
the first link includes:
a structural bridge extending between the third and fourth planes, wherein a radial distance between the first annular peripheral region of the first transfer member and the axis is less than a radial distance between the structural bridge and the axis, and wherein a radial distance between the second annular peripheral region of the second transfer member and the axis is less than a radial distance between the structural bridge and the axis,
a first structural connector extending between the rods and the structural bridge via the first end portions of the rods, and
a second structural connector extending between the rods and the structural bridge via the second end portions of the rods;
the first structural connector and a first portion of the structural bridge is at the first portion of the body; and
the second structural connector and a second portion of the structural bridge is at the second portion of the body.

9. The actuator assembly of claim 1, wherein:
the first link includes:
a first body neighboring the joint in one of a proximal or distal direction, and
a first cap at a first end portion of the joint; and
the second link includes:
a second body neighboring the joint in the other of the proximal or distal direction, and
a second cap at a second end portion of the joint spaced apart from the first end portion of the joint along the axis.

10. The actuator assembly of claim 9, wherein:
the first cap and the first body define a first channel extending away from the joint in the one of the proximal or distal direction;
the second cap and the second body define a second channel extending away from the joint in the other of the proximal or distal direction;
the actuator assembly includes a conduit defining a third channel extending along the axis between the first and second channels; and
the stator and the rotor extend circumferentially around the conduit.

11. The actuator assembly of claim 10, further comprising wiring extending between the first and second links via the first, second, and third channels.

12. The actuator assembly of claim 1, wherein:
the actuator assembly further comprises pins circumferentially distributed about the axis;
the second link includes a collar carrying the pins; and
the gearing is configured to transfer torque to the collar via the pins.

13. The actuator assembly of claim 12, wherein:
the first link includes a stator mount carrying the stator; and
the actuator assembly includes an annular roller bearing between the stator mount and the collar.

14. The actuator assembly of claim 13, wherein the annular roller bearing is at the third plane.

15. A method comprising:
operating a motor of an actuator assembly to cause relative rotation between first and second links of the actuator assembly, wherein operating the motor includes rotating a rotor of the motor relative to a stator of the motor about an axis; and
changing an output of the motor via cycloidal gearing of the actuator assembly while:
rods of the actuator assembly are circumferentially distributed about the axis and individually include a first end portion and an opposite second end portion,
the rods individually extend through different respective sets of a first opening defined by a first transfer member of the cycloidal gearing and a second opening defined by a second transfer member of the cycloidal gearing, and
the first link structurally braces the rods via the first and second end portions of the rods.

16. The method of claim 15, further comprising transferring torque from the first and second transfer members to pins of the actuator assembly circumferentially distributed about the axis while changing the output of the motor.

17. The method of claim 16, wherein transferring torque from the first and second transfer members to the pins includes transferring torque from the first and second transfer members to the pins while a collar of the second link carries the pins.

18. The method of claim 17, wherein:
transferring torque from the first and second transfer members to the pins includes:
transferring torque from the first transfer member to at least some of the pins via a first annular peripheral region of the first transfer member, and
transferring torque from the second transfer member to at least some of the pins via a second annular peripheral region of the second transfer member; and
changing the output of the motor includes changing the output of the motor while:
the first openings are at a first annular inner region of the first transfer member between the first annular peripheral region and the axis, and
the second openings are at a second annular inner region of the second transfer member between the second annular peripheral region and the axis.

19. The method of claim 18, wherein:
the method further comprises:
transferring torque from the rotor to an input shaft of the actuator assembly,
transferring force from the input shaft to the first transfer member via a first eccentric bearing of the actuator assembly carried by the input shaft at a first plane perpendicular to the axis,
transferring force from the input shaft to the second transfer member via a second eccentric bearing of the actuator assembly carried by the input shaft at a second plane perpendicular to the axis; and
changing the output of the motor includes changing the output of the motor while:
the first end portions of the rods are at a third plane perpendicular to the axis,
the second end portions of the rods are at a fourth plane perpendicular to the axis, and
the first and second planes are between the third and fourth planes.

20. The method of claim 19, wherein changing the output of the motor includes changing the output of the motor while:
a first structural connector of the first link structurally braces the rods via the first end portions of the rods;
a second structural connector of the first link structurally braces the rods via the second end portions of the rods;
a structural bridge of the first link structurally connects the first and second structural connectors to one another;
the structural bridge extends between the third and fourth planes;
a radial distance between the first annular peripheral region of the first transfer member and the axis is less than a radial distance between the structural bridge and the axis; and
a radial distance between the second annular peripheral region of the second transfer member and the axis is less than a radial distance between the structural bridge and the axis.
